(19) United States
(12) Patent Application Publication
(10) Pub. No.: US 2021/0153660 A1
(43) Pub. Date: May 27, 2021

(54) Sleeping Headrest Cushion and Strap

(71) Applicant: Lance B. Gockel, Shawnee, KS (US)

(72) Inventor: Lance B. Gockel, Shawnee, KS (US)

(73) Assignee: Lance B Gockel, Shawnee, KS (US)

(21) Appl. No.: 16/693,436

(22) Filed: Nov. 25, 2019

(51) Int. Cl. A47C 7/38; A47G 9/10

(52) U.S. Cl. CPC A47C 7/383; B60N 2/882; A47G 2009/1018; A47G 9/1009

(57) ABSTRACT

A head rest including: a Cushion and an Attachment Strap. The Cushion has a Pillow and Rigid Member with a back portion and two side portions generally U shaped such that the Cushion can form a compressible fit around the back of a person's head at or near the ear level. The exterior of the back portion of the Cushion is shaped to mate with a seat back and has attachment means such as Velcro on the outside. The Attachment Strap securely fits around the seat back and has a means such as Velcro for engaging the Cushion in order to hold the Cushion upright and in place. The Cushion can supply lateral or horizontal support a person's head in all directions because it is attached to the seat back and has a compression fit on a person's head.

### BACKGROUND OF INVENTION

The Sleeping Headrest Cushion and Strap invention relates to a headrest, a support structure and a means for attachment to a headrest. In particular, it relates to attaching a Cushion to a seat back and supporting the Cushion from the seat back such that an individual can rest or sleep in a moving vehicle or plane without their head moving in an uncomfortable manner.

Headrest cushions commonly attempt to support the head by utilizing cushions resting on the shoulders or neck. Because the neck is vertical and shoulders are so far below the head, the geometries of such devises render them non-functional for support and leave a passenger's head flopping forward and sideways in an uncontrolled manner

Some improvements have been made which attach the headrest cushion to the seatback. Unfortunately, these seatback attached headrest cushions have limited flexibility horizontally, vertically and rotationally and do not securely retain the head in a position of comfort, particularly keeping the head from falling forward. Some such improved Cushions show attachment means that are not actually available on airline seats. Finally, those improved cushion attachment mechanisms are expensive, not very portable, heavy, unsafe due to size and overly difficult to attach to the seatback or existing headrest and often violate airline regulations.

Therefore, a need exists for a headrest cushion that is easy to install on an existing car or plane seat or seatback, which has the ability for a user to significantly adjust in the horizontal, vertical and rotational directions including a simple and inexpensive means to hold the head in a comfortable position.

### BRIEF SUMMARY OF INVENTION

The invention is comprised of 2 major parts: The Cushion and the Attachment Strap. The Cushion contains an Attachment Surface which adheres to the Attachment Strap, after the Strap is wrapped around the vehicle/plane seatback or headrest. This invention is separated from present art, by designing the Headrest for placement on a person's head at ear level or above and then designing a Cushion/Strap system such that the head can be simply and inexpensively supported by the seatback. The adjustable yet rigid attachment of a person's head to a seat by way of compression fit from a supported cushion with a reusable attachment such as Velcro has not be previously utilized.

The Cushion is made of a U shaped Pillow comprised of compressible material such as foam, surrounded by a U shaped Rigid Member, a fabric Cover and an Attachment Surface such as Velcro fixed on the Cover at the flat back portion of the Cushion. The Cushion can be adjusted both horizontally and vertically relative to the Attachment Strap because only a portion of the Cushion Attachment Surface needs to engage the Strap. For laying the head to one side at an angle, the Cushion can be rotated such that the head is allowed to recline to one side. The Cushion forms a compression fit with a person head, normally about the ear level, hence retaining the head in the Cushion despite a person's inclination to lean forward while sitting at sleep. As a person leans to one side, the Rigid Member is supported by the taunt Velcro Strap and hence supports the head. The Cushion can surround the ears and acts as a soundproof barrier or be placed above the ears to improve comfort or functionality.

The Attachment Strap can be wrapped around various sized seatbacks and positioned vertically on the headrest as desired for taller or shorter individuals. The Attachment Strap can be substantially covered with Velcro loop to engage the hook material on the Cushion. A small end portion of the Strap consists of Velcro hook material which is threaded through a Ring on the opposite end of the Strap and then lapped back to the Strap hook material, thereby forming a circle which can be tightened to various sized headrests in taunt manner. A portion of the Strap may also consist of elastic material so the strap may be slipped around the seat or headrest without unloosing the strap end. Hence, differences in sizes of headrest may be accommodated by the elastic material without the need to adjust the strap manually; this elastic feature also allows the head to rest closer to u-shaped seatback.

### BRIEF DESTRIPTION OF DRAWINGS

FIG. 1—Depicts a person sitting in a seat with the Cushion placed about the head and a strap wrapped around the seatback.

FIG. 2—Is a plan view of a person's head in a compressed fit with the Cushion.

FIG. 3—Is a rear view of the Cushion with the Velcro shown on the back of the Cushion.

FIG. 4—Is a view of the Attachment Strap indicating portions of both hook and loop portion of Velcro, plus a ring for looping the Attachment Strap through so Velcro can be lapped back on itself.

FIG. 5—Is a view of the Attachment Band showing an alternative to the Attachment Strap in the form of a closed loop Expandable Band and an Attachment Ribbon lapped over the top of the seat back.

### DETAILED DESCRIPTION OF THE INVENTION

The present disclosure is to be considered as an exemplification of the invention, and is not intended to limit the invention to the specific embodiments illustrated by the figures or description below.

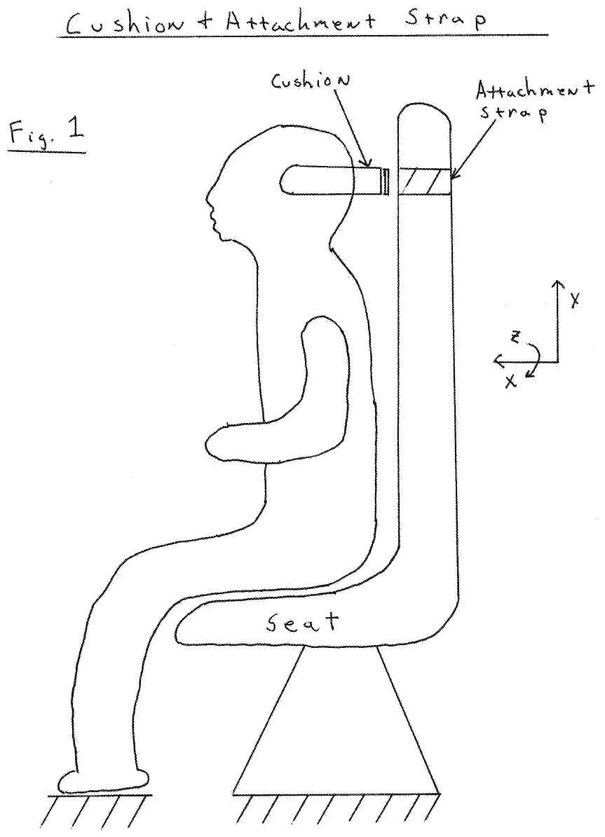

The present invention will now be described by referencing the appended figures representing preferred embodiments. The two major parts of the invention are the Cushion and the Attachment Strap as shown in FIG. 1 which allows a user to sit in a seat with their head supported while sleeping or at rest.

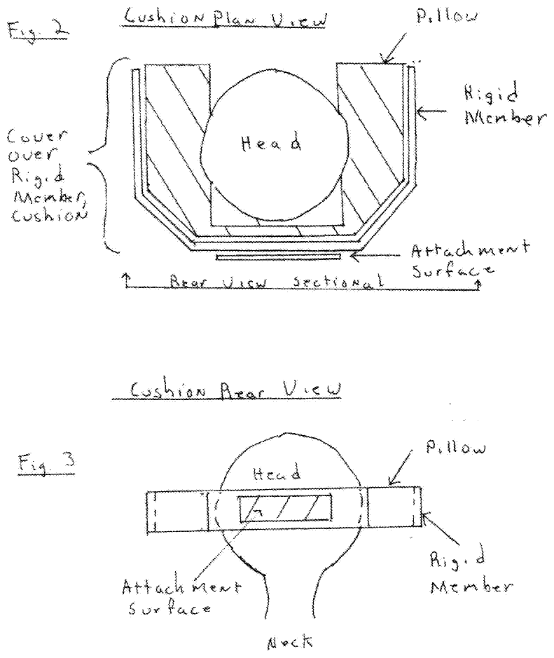

The Cushion as shown if FIGS. 2 & 3 consists of a compressible Pillow, a Rigid Member supporting structure, a Cover and an Attachment Surface. The Pillow, Rigid Member and Cover are all U-shaped such that they fit around a person's head. The Attachment Surface is somewhat flat in nature so that it can adhere to the flat Attachment Strap described below. As shown in FIG. 2, the cover encapsulates the compressible pillow and the Rigid Member. The Cushion can be manufactured in various external/internal height, width, depth and diameters to accommodate different sized heads.

The compressible Pillow is sized such that it forms a compression fit with a person's head. This interference fit is important to supporting a person's head. The compression fit is enhanced by the surrounding Rigid Member. This fit prevents a person head from moving once inserted in the U shaped Cushion. Preferred material for the pillow is foam but other materials may also be utilized.

The Rigid Member as shown in FIG. 2, surrounds the outside perimeter of the pillow providing a frame against which the foam is compressed. It is U shaped in structure with 2 side members and a back side member. These members could be modified to be a single member bent into a U shape. The back side member is flat in the middle such that it can be placed adjacent to and parallel with a flat seat back or vehicle headrest. The back of the Rigid Member can be shaped to interlock with the angles of the seatback. The side pieces are cantilevered out from the back piece in order to provide side support for a leaning head. The height and width of the back and side pieces should fit snugly inside the Cover such that the Pillow and Rigid Member stay in place during use. The Rigid member can be shaped such that it fits the concave contours of a headrest. The engagement between the similarly shaped Rigid Member and existing headrest may gently support the Cushion vertically, horizontally and rotationally without the need for a Strap.

The Cover encapsulates the foam and the Rigid Member or just part of the Rigid Member such as the sides. In the preferred configuration, the cover would encapsulate both the Pillow and the Rigid Member with a soft fabric comfortable to rest against and of sufficient strength to not stretch substantially when leaned against. The Attachment Surface described below may be an integral part of the cover or may be attached to the Cover. The Cover may include a zipper to allow access to the foam and Rigid Member.

The Pillow Attachment Surface shown in FIG. 3 is affixed to the flat back side of the Cushion. The Attachment Surface may be affixed to either the Cover or Rigid Member. This Attachment Surface has one outward side that can be repetitively adhered to the Attachment Strap described below. The preferred Attachment Surface is made of a material like Velcro, but any type of reusable attachment means would be functional. The Velcro surface should be maximized in height and width in order to expand the area on the Cushion that may be attached to the Attachment Strap. This large attachment piece allows the pillow to be moved vertically (y axis,) horizontally (x axis), or rotationally (z axis) relative to the seat as shown in FIG. 1, since only a portion of the Velcro piece needs to interlock with Attachment Strap. Additionally, the Cushion may contain a means to rigidly fix the Pillow Attachment Surface to the Rigid Member, such as glue, in order to maximize support.

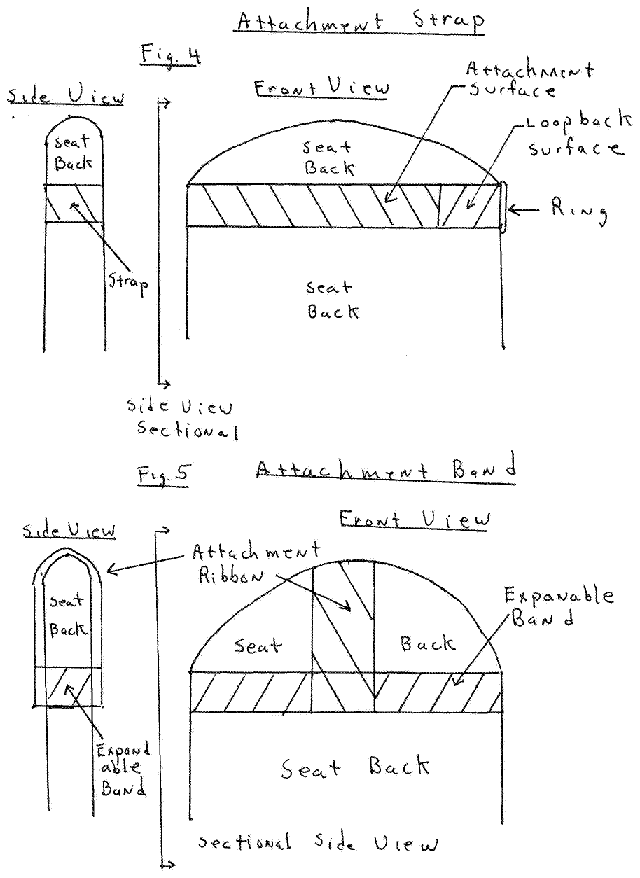

The Attachment Strap shown in FIG. 4 consists of a strap having a reusable adhesive surface such as Velcro loop on a large portion of the strap and the reusable surface such as Velcro hoop on the remainder. The Strap may utilize a Ring allowing the strap to be doubled back on itself so the loop and hook can be interlocked. A buckle or other commonly known adjustable strapping means may also be utilized instead of Velcro for wrapping the strap around the seat. The Strap can be wrapped around a seat or headrest at various heights depending on the user's height and preference.

An alternative to the Attachment Strap is an Attachment Band. It consists of an Expandable Band that can be stretched around a seat back as shown in FIG. 5. An Attachment Ribbon is connected to the opposite sides of the Expandable Band and lapped over the seatback, allowing the Attachment Ribbon to stay centered on multiple sized seats. The Attachment Ribbon is composed of a material such as Velcro that can engage the Attachment Surface of the Pillow. This alternative offers the advantage of easy installation and allows the Cushion to lie directly adjacent to curved airline headrests because the Ribbon is not overly taunt.

Attachment and placement of the Cushion relative to the Strap are flexible. Since both the Strap and Cushion may be adjusted for height, significant vertical adjustment (y axis) can be attained. The Velcro Loop portion of the strap should be positioned across the seat such that the Loop portion is accessible side to side (x axis). This allows the Cushion to be placed anywhere within the seat framework side to side and still engage the strap. The Cushion can also be rotated such that the head can be tilted and still retain the sides of the head parallel to the inside portion of the Cushion. The attachment of the Cushion to the strap is as simple as using one hand to push it against the desired location (x and y location) and rotation (z angle) on the strap. Such an attachment is also relatively inexpensive.

Although the present invention has been illustrated and described herein with reference to preferred embodiments and specific example thereof, it will be readily apparent to those of ordinary skill in the art that other embodiments and examples may perform similar function and/or achieve like results. All such equivalent embodiments and examples are within the spirit and scope of the present invention, are contemplated thereby, and are intended to be covered.

1) A Sleeping Headrest Cushion comprising:
a) a Pillow made of compressible material like foam shaped in the form of a U having interior dimensions that ensure an interference fit with a person's head when placed on the back of the head at or near the ear level;
b) a Rigid Member having a back portion and two opposing side portions surrounding the outside perimeter of the Pillow and shaped in the form of a U, with the back portion contour that mechanically meshes with the shape of a seat back; and
c) a Cover that captures internally the Pillow and Rigid Member.

2) A Sleeping Headrest Cushion and Attachment Strap comprising:
a) A Cushion including:
i) a Pillow made of compressible material like foam shaped in the form of a U having interior dimensions that ensure an interference fit with a person's head when placed on the back of the head at or near the ear level;
ii) A Rigid Member having a back and two opposing side portions shaped in the form of a U and surrounding the outside of the Pillow with a convex back portion that matches the concave contour of the seat back and side portions of sufficient length to provide structural support for a head and ensuring a compressible fit of the head within the Pillow;
iii) A Cover that captures the Pillow and Rigid Member; and
iv) A Cushion Attachment Surface, comprised of a releasable material such as Velcro, fixedly attached to the back of the Cover such that it can engage the Attachment Strap Surface.
b) An Attachment Strap including:
i) A Strap of sufficient length to wrap around a seat back;
ii) A Strap Attachment Surface, is comprised of a releasable material such as Velcro, fixedly attached to one side of the strap that can mate with the Cushion Attachment Surface and the Strap Loopback Surface;
iii) A Ring fixed on one end of the strap for threading the strap through the Ring and then back upon itself; and
iv) A Strap Loopback Surface, comprise of releasable material such as Velcro hook, on the opposite end of the strap from the Loop but on the same side of the Strap as the Attachment Surface such that when the strap is looped back on itself, the Loopback Surface can mate with the Strap Attachment Surface.

3) A Sleeping Headrest Cushion as in claim 2 that utilizes an Attachment Band rather than an Attachment Strap as described in 2b. The Attachment Band includes a closed loop Expandable Band that slips over the seat back and an Attachment Ribbon, composed of a releasable material, generally at 90 degrees to the Expandable Band. The Attachment Ribbon ends are attached to the opposite sides of the Expandable Band. The Attachment Ribbon is held on the seat back by the Expandable band and laps over the seat to allow the Attachment Ribbon to engage the Cushion Attachment Surface and hold the Cushion in place.
